(19) United States
(12) Patent Application Publication
(10) Pub. No.: US 2013/0016026 A1
(43) Pub. Date: Jan. 17, 2013

(54) BROADBAND INTERNAL ANTENNA USING ELECTROMAGNETIC COUPLING SUPPORTING IMPROVED IMPEDANCE MATCHING

(71) Applicants: Su-Hyun Choi, Seoul (KR); Sung-Nam An, Seoul (KR); Byoung-Nam Kim, Gyeonggi-do (KR); Seung-Yong Lee, Gyeonggi-do (KR); Jong-Ho Jung, Gyeonggi-do (KR)

(72) Inventors: Su-Hyun Choi, Seoul (KR); Sung-Nam An, Seoul (KR); Byoung-Nam Kim, Gyeonggi-do (KR); Seung-Yong Lee, Gyeonggi-do (KR); Jong-Ho Jung, Gyeonggi-do (KR)

(73) Assignee: ACE & PARTNERS, Incehon (KR)

(21) Appl. No.: 13/637,960

(22) PCT Filed: Mar. 29, 2011
(86) PCT No.: PCT/KR2011/002128

§ 371 Date: Sep. 27, 2012

(30) Foreign Application Priority Data
Mar. 31, 2010 (KR) 10-2010-0029083

(51) Int. Cl. H01Q 1/50

(52) U.S. Cl. 343/860

(57) ABSTRACT

Disclosed is an internal antenna using electromagnetic coupling that supports improved impedance matching. The antenna includes a first conductive member having one end electrically connected with a power feed point; a second conductive member separated from the first conductive member by a particular distance and electrically connected with a ground; a radiator extending from the second conductive member; and a grounding plate joined with the other end of the first conductive member. This antenna provides the advantages of adequately ensuring wide-band and multi-band characteristics while improving impedance matching properties.

### TECHNICAL FIELD

The present invention relates to an internal antenna, more particularly to a wide-band internal antenna using electromagnetic coupling.

### BACKGROUND ART

As current mobile communication terminals become smaller and lighter, there is also a demand for slimmer structures of the terminals. In spite of the continued demand for smaller sizes, the mobile communication terminal is expected to provide more varied functionality.

In order to provide smaller mobile communication terminals with greater functionality, it is required to minimize the space occupied by the antenna within the mobile communication terminal. This can further increase the burden in designing the antenna.

Moreover, in recent times, there is a trend towards the “convergence” terminal, which is capable of accommodating services of various frequency bands within a single terminal. Accordingly, wide-band and multi-band characteristics have become the most important elements of an antenna. An antenna may thus be required to support services of various bands including, for example, near field communication services such as Bluetooth, mobile communication services, and wireless LAN services.

The antennas generally used for mobile communication terminals include the helical antenna and the planar inverted-F antenna (PIFA).

The helical antenna is formed with a shape protruding from the exterior of the terminal, and it is thus difficult to design the appearance of the terminal to be aesthetically pleasing and be suitable for carrying. There has not been much research on an embedded structure for the helical antenna, and as such, may not be suitable for use under current trends that require internal antennas.

The inverted-F antenna is designed to have a low profile structure, so as to allow embedding into a terminal. The inverted-F antenna has directivity, and when current induction to the radiating part generates beams, a beam flux directed toward the ground surface may be re-induced to attenuate another beam flux directed toward the human body, thereby improving SAR characteristics as well as enhancing beam intensity induced to the radiating part. Also, the inverted-F antenna operates as a rectangular micro-strip antenna, in which the length of a rectangular plate-shaped radiating part is reduced in half, whereby a low profile structure may be realized.

The inverted-F antenna thus provides many advantages in terms of its small size and its radiating properties, and it is the type of internal antenna currently used the most. However, the inverted-F antenna has the drawback of having narrow band characteristics, and hence, it is difficult to design the antenna to provide multi-band and wide-band characteristics.

In order to overcome this problem of the inverted-F antenna, an internal antenna using electromagnetic coupling was proposed, and FIG. 1 illustrates the structure of the internal antenna using electromagnetic coupling proposed in the past.

The internal antenna using electromagnetic coupling having the structure illustrated in FIG. 1 can provide wider band characteristics compared to the inverted-F antenna, but there is the problem of degraded impedance matching at certain bands when the antenna is designed to provide multi-band characteristics.

### DISCLOSURE

### Technical Problem

To resolve the problems in prior art described above, an objective of the present invention is to propose a wide-band internal antenna that can adequately ensure wide-band and multi-band characteristics while improving impedance matching properties.

Another objective of the present invention is to provide an internal antenna that uses electromagnetic coupling to provide wide-band characteristics while allowing easy implementation of multiple bands.

Additional objectives of the present invention will be obvious from the embodiments described below.

### Technical Solution

An aspect of the present invention provides an internal antenna with improved impedance matching using electromagnetic coupling that includes: a first conductive member having one end electrically connected with a power feed point; a second conductive member separated from the first conductive member by a particular distance and electrically connected with a ground; a radiator extending from the second conductive member; and a grounding plate joined with the other end of the first conductive member.

The antenna can further include a dielectric structure to which the first conductive member, the second conductive member, and the grounding plate may be joined.

The grounding plate may preferably be positioned on the dielectric structure at an opposite side of the radiator.

A traveling wave may be generated in the first conductive member and the second conductive member

The antenna can further include a multiple number of first protrusions protruding from the first conductive member towards the second conductive member.

The antenna can further include a multiple number of second protrusions protruding from the second conductive member towards the first conductive member.

Another aspect of the present invention provides an internal antenna with improved impedance matching using electromagnetic coupling that includes: a first conductive member having one end electrically connected with a power feed point; a second conductive member separated from the first conductive member by a particular distance and electrically connected with a ground; and a radiator extending from the second conductive member, where electromagnetic coupling occurs from the first conductive member to the second conductive member at a particular area of the first conductive member and the second conductive member, and the first conductive member operates as a loop radiator.

### Advantageous Effects

The present invention provides a wide-band internal antenna that can adequately ensure wide-band and multi-band characteristics while improving impedance matching properties.

### DESCRIPTION OF DRAWINGS

FIG. 1 illustrates the structure of an internal antenna using electromagnetic coupling, proposed by the inventors.

FIG. 2 is a plan view illustrating the structure of an internal antenna using electromagnetic coupling according to an embodiment of the present invention.

FIG. 3 illustrates an example in which an antenna according to an embodiment of the present invention is formed joined to a dielectric structure.

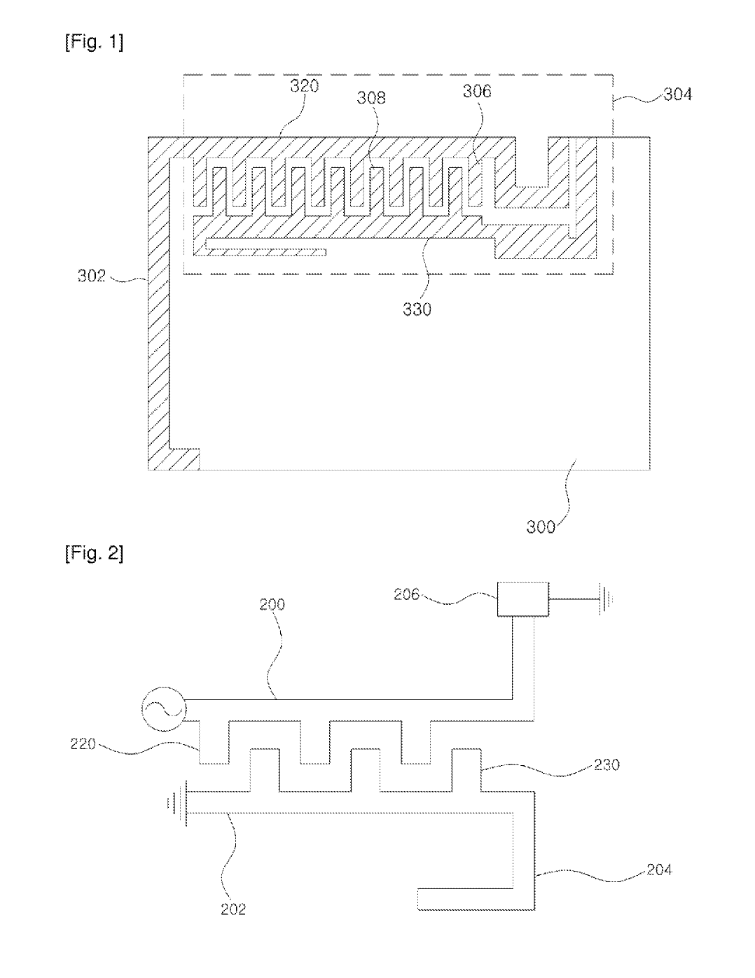

### MODE FOR INVENTION

The wide-band internal antenna using electromagnetic coupling and having a spiral structure according to certain embodiments of the present invention will be described below in more detail with reference to the accompanying drawings.

FIG. 2 is a plan view illustrating the structure of an internal antenna using electromagnetic coupling according to an embodiment of the present invention.

Referring to FIG. 2, an internal antenna using electromagnetic coupling according to an embodiment of the present invention can include a first conductive member 200, a second conductive member 202, a radiator 204, and a grounding plate 206.

The first conductive member 200 may be electrically connected with a power feed point. The first conductive member 200 may be separated from the second conductive member 202 in a particular area, by a distance that allows electromagnetic coupling.

The second conductive member 202 may be electrically connected with a ground and may be separated from the first conductive member 200. The first conductive member 200 may have one end connected with the power feed point, as described above, and may have the other end electrically joined with the grounding plate 206.

Through the power feed point, an RF signal may be delivered to the first conductive member 200, and electromagnetic coupling may occur from the first conductive member 200 to the second conductive member 202. The RF signal may be delivered to the second conductive member 202 via electromagnetic coupling. During the electromagnetic coupling from the first conductive member 200 to the second conductive member 202, a traveling wave can be generated.

In addition to delivering the RF signal to the second conductive member 202 by electromagnetic coupling, the first conductive member 200 may itself operate as a loop radiator. As illustrated in FIG. 2, the first conductive member 200 may have the other end joined with the grounding plate 206, and may thus operate as a loop radiator having one end grounded.

Here, the radiating frequency of the loop radiator may be determined by the length of the first conductive member 200. The grounding plate 206 may be formed in a position opposite to that of the radiator 204 (if the antenna is formed on a dielectric structure, on the opposite side of the portion where the radiator is formed) and joined with the first conductive member 200.

According to the inventors' research, making the first conductive member 200 and the second conductive member 202 relatively long, so as to ensure sufficient coupling between the first conductive member 200 and the second conductive member 202 separated by a particular distance, can provide wider band characteristics.

However, since providing the first conductive member 200 and second conductive member 202 with great lengths would cause difficulties in reducing the size of the antenna, an embodiment of the present invention may include first protrusions 220 and second protrusions 230 that form a traveling wave structure, which makes it possible to ensure sufficient coupling even when the lengths of the first conductive member 200 and second conductive member 202 are relatively short.

A multiple number of first protrusions 220 may protrude from the first conductive member 200 in the direction of the second conductive member 202, and a multiple number of second protrusions 230 may protrude from the second conductive member 202 in the direction of the first conductive member 200.

As illustrated in FIG. 2, the multiple numbers of first protrusions 220 and second protrusions 230 may preferably be formed to protrude alternately and mesh with one another. The first protrusions 220 and second protrusions 230 protruding from the first conductive member 200 and second conductive member 202 may protrude like open stubs, thereby substantially increasing the electrical lengths of the first conductive member 200 and second conductive member 202 and making it possible to obtain wider band characteristics.

Although FIG. 2 illustrates an example in which the protruding lengths and widths of the first protrusions 220 and second protrusions 230 are the same, the widths and lengths of the first protrusions 220 and second protrusions 230 can be made to be partially different. Also, while FIG. 2 illustrates an example in which the shapes of the first protrusions 220 and second protrusions 230 are rectangular, the shapes of the protrusions are not thus limited.

The first conductive member 200 and the second conductive member 202 may, by means of electromagnetic coupling, operate as a power feed part and an impedance matching part, while the radiator 204 extending from the second conductive member 202 may serve to radiate RF signals.

The radiating frequency of the antenna may be determined by the length of the radiator 204 on the second conductive member 202. As described above, the radiator 204 may be positioned on the opposite side of the grounding plate.

In the antenna based on an embodiment of the present invention illustrated in FIG. 2, a first radiation is performed by the first conductive member 200, while a second radiation is performed by the radiator 204. The first conductive member having a relatively shorter electrical length may perform the first radiation in a low band, while the radiator 204 having a relatively longer electrical length may perform the second radiation in a high band. Since the grounding plate 206 and the radiator 204 may be positioned on opposite sides, there may be no interference between the first radiation and the second radiation, and the paths of the currents for the radiation may also be formed independently.

In an existing antenna using electromagnetic coupling, it is typical to implement multi-band characteristics by forming the radiator, which extends from the second conductive member, as a branching structure. However, when implementing a branch structure extending from the second conductive member, there may be the problem of lowered radiation efficiency resulting from insufficient impedance matching in certain bands.

In an embodiment of the present invention, the first conductive member 200, used for coupling power feed and matching, may be connected with the grounding plate 206 in an opposite direction of the radiator and may thus be utilized as a loop radiator, thereby making it possible to compensate for the degraded impedance matching and to implement the radiator 204 as a simpler structure.

The components described above according to an embodiment of the present invention can be joined to a dielectric structure such as a carrier or a substrate, to operate as an antenna.

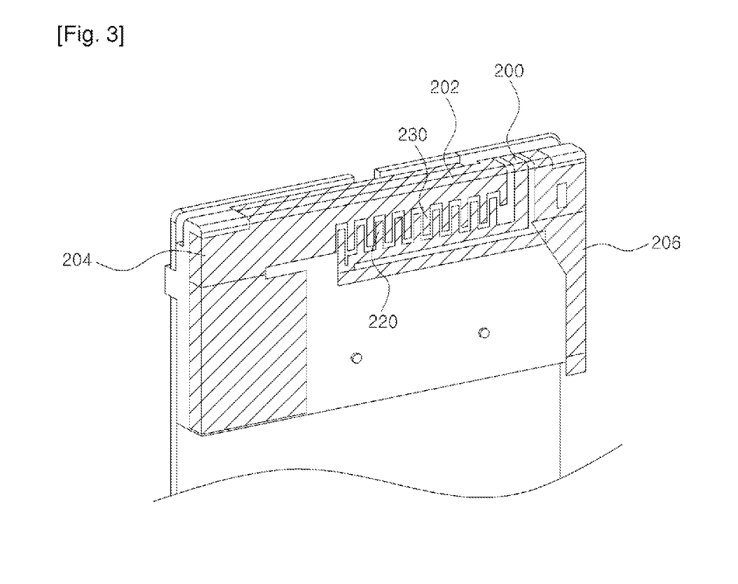

FIG. 3 illustrates an example in which an antenna according to an embodiment of the present invention is formed joined to a dielectric structure. As illustrated in FIG. 3, an antenna according to an embodiment of the present invention can be joined to the upper portion and side portions of a dielectric structure, to thus implement multi-band characteristics while enabling the first conductive member to operate as a loop radiator.

While the present invention has been described with reference to particular embodiments, it is to be appreciated that various changes and modifications can be made by those skilled in the art without departing from the spirit and scope of the present invention, as defined by the appended claims and their equivalents.

1. An internal antenna with improved impedance matching using electromagnetic coupling, the antenna comprising:
a first conductive member having one end thereof electrically connected with a power feed point;
a second conductive member separated from the first conductive member by a particular distance and electrically connected with a ground;
a radiator extending from the second conductive member; and
a grounding plate joined with the other end of the first conductive member.

2. The antenna of claim 1, further comprising:
a dielectric structure having the first conductive member, the second conductive member, and the grounding plate joined thereto.

3. The antenna of claim 2, wherein the grounding plate is positioned on the dielectric structure at an opposite side of the radiator.

4. The antenna of claim 3, wherein a traveling wave is generated in the first conductive member and the second conductive member.

5. The antenna of claim 1, further comprising a plurality of first protrusions protruding from the first conductive member towards the second conductive member.

6. The antenna of claim 4, further comprising a plurality of second protrusions protruding from the second conductive member towards the first conductive member.

7. An internal antenna with improved impedance matching using electromagnetic coupling, the antenna comprising:
a first conductive member having one end thereof electrically connected with a power feed point;
a second conductive member separated from the first conductive member by a particular distance and electrically connected with a ground; and
a radiator extending from the second conductive member,
wherein electromagnetic coupling occurs from the first conductive member to the second conductive member at a particular area of the first conductive member and the second conductive member, and the first conductive member operates as a loop radiator.
